(19) United States
(12) Patent Application Publication
(10) Pub. No.: US 2025/0163932 A1
(43) Pub. Date: May 22, 2025

(54) METHOD FOR ASSEMBLING METAL PIECES OF DIFFERENT MASSIVENESS AND CENTRIFUGAL DIFFUSER PRODUCED BY THIS METHOD

(71) Applicant: SAFRAN HELICOPTER ENGINES, BORDES (FR)

(72) Inventors: Thibaut LARROUY, MOISSY CRAMAYEL (FR); Daniel EZCURRA, MOISSY CRAMAYEL (FR); Lionel SCUILLER, MOISSY CRAMAYEL (FR)

(21) Appl. No.: 18/869,975

(22) PCT Filed: May 30, 2023
(86) PCT No.: PCT/FR2023/050755

§ 371 Date: Nov. 27, 2024

(30) Foreign Application Priority Data
May 30, 2022 (FR) 2205145

(51) Int. Cl. F04D 29/44; B23K 15/00; B23K 101/00; B23P 15/00; F04D 29/54; F04D 29/62

(52) U.S. Cl. CPC F04D 29/444; B23K 15/0046; B23P 15/006; F04D 29/542; F04D 29/624; B23K 2101/001; F05D 2230/234

(57) ABSTRACT

A method for assembling a first metal part to a second metal part, the first and second metal parts having different sizes, the method including the following operations a) producing a slot in a surface of the first metal part; b) positioning the second metal part in line with the slot of the first metal part; and c) welding the second metal part to the first metal part through the slot using a high-energy welding beam, the slot guiding the welding beam.

### TECHNICAL FIELD OF THE INVENTION

The present invention relates to a method for assembling first and second metal pieces of different massiveness (or bulkiness), wherein the second piece is welded to the first piece through a slot made within the first piece. The invention also relates to an assembly, obtained by this method, of a metal cover and at least one metal blade, as well as to a centrifugal diffuser for a turbomachine including such an assembly.

The invention finds applications in the field of aeronautics and, in particular, in the field of assembling metal pieces for aircraft turbomachines.

### TECHNOLOGICAL BACKGROUND OF THE INVENTION

Aircraft turbomachines, especially those of the gas turbine type, include different stages mounted about a central rotation shaft. An example of a turbomachine is schematically represented in FIG. 1. In this example, the turbomachine 10 includes a rotation shaft 11 extending along a central axis AA and about which a fan 12, a compressor 13, a combustion chamber 14 and a turbine 15 are mounted, in the upstream to downstream direction. When the turbomachine 10 is operating, an air flow enters the turbomachine through the fan 12; this air flow is then compressed by the compressor 13, then mixed and burnt with fuel in the combustion chamber 14 before being expanded in the low-pressure turbine 15 and then discharged through a nozzle 16.

At the outlet of the compressor 13, a centrifugal diffuser 20 conveys the air flow towards the compression chamber 14. This centrifugal diffuser 20, referred to more simply as a diffuser, includes a partially planar circular cover to which blades are attached. Generally, the blades are attached by soldering to the cover. Soldering is usually carried out by manually applying solder to the tops of the blades, followed by heat treatment at high temperature, i.e. around 1150° C. The drawback of this soldering operation is that it causes significant deformation of the centrifugal diffuser 20; in particular, it deforms planarity of the distributor. This soldering operation can, for example, generate distortions, as represented in FIG. 2, with a rate that can range from +/−0.2 to +/−0.5. This deformation of the distributor planarity is partly random and therefore uncontrolled. In fact, the radii of solder formed between the tops of the blades and the walls of the cover are difficult to control and often difficult to reach. According to the quantity of solder deposited, the solder may spread out on the blade and, by capillary action, in the radial air stream delimited by the diffuser, which may lead to a modification of the metallurgical structure of the diffuser, outside the assembling zone.

As the solder is applied manually, problems of poor wettability of the solder may also be generated and/or lack of solder, which are relatively random and difficult to avoid. The only known solution to these problems is to make resolder operations, sometimes a lot. However, each resolder operation requires a complete soldering cycle, and therefore a new high temperature heat treatment. As the heat treatment causes the diffuser to deform, it is understood that the more heat treatments the diffuser is subjected to, the greater is the deformation.

To reduce risks related to soldering the blades to the cover, manufacturers of centrifugal diffusers have contemplated replacing the soldering operation with an electron beam welding operation, also referred to as EBW (or EB welding). Indeed, using EBW would reduce the risk of soldering radii, dripping and wetting. However, EBW requires pieces of different massiveness, especially of different thicknesses, to be molten together over a short distance. Indeed, a diffuser cover is at least 2 mm thick, while the top of the blades to be welded to the cover is generally between 0.3 mm and 2 mm thick. An example of a centrifugal diffuser blade profile is represented in FIG. 3. This example shows that the thickness of the blade is progressive, with a maximum thickness of about 2 mm at the centre of the blade and a minimum thickness of about 0.3 mm to 0.5 mm at the ends of the blade and therefore at the top of the blade. This difference in massiveness between the top of the blade and the cover prevents these two zones from being molten together, especially as assembly is carried out from the external face of the cover (i.e. the face opposite to the face to which the blade is attached), the electron beam being positioned above the external face of the cover.

The operation of assembling the blade and the cover by EBW gives rise to another drawback. Indeed, the assembly between the blade and the cover is traditionally carried out using the soldering technique, according to a configuration referred to as a ‘through blade’ and a configuration referred to as a ‘non-through blade’. An example of the through configuration is represented in FIG. 5A and an example of the non-through configuration is represented in FIG. 5B. In the through configuration, the top 22a of the blade passes through the cover 21 via an adapted aperture and projects from the external face 21a of the cover. In the non-through configuration, the top 22a of the blade is positioned against the internal face 21b of the cover. These two configurations, used together for a same diffuser, have been defined to enable positioning the cover in relation to the blades and to obtain improved mechanical strength of the junction.

While the through configuration is adapted to EBW, the non-through configuration leads to instability of the electron beam with deflection of the beam at the top of the blade during EBW. FIG. 4 schematically represents an electron beam EB during EBW at the junction between the cover 21 and the top 22a of the diffuser blade 22, in the non-through configuration. The deflection of the EB electron beam, represented by arrows on either side of the top 22a of the blade, prevents the assembly of the cover and the blade by locally melting the materials. Blades mounted in a non-through configuration cannot therefore be attached to the cover by EBW.

There is therefore a real need for a solution for assembling a blade to a diffuser cover by EBW.

### SUMMARY OF THE INVENTION

In response to the problems discussed above with the assembly of blades on a centrifugal diffuser cover, the applicant provides a high energy welding assembly method, such as EBW, wherein the welding beam is guided by means of a slot made in the surface of the cover. The applicant also provides an assembly of metal pieces obtained by this method.

According to a first aspect, the invention relates to a method for assembling a first metal piece to a second metal piece, the first and second metal pieces having different massiveness, characterised in that it includes the following operations of:
making a slot on a surface of the first metal piece,
positioning the second metal piece in line with the slot in the first metal piece, and
welding, through the slot, the second metal piece to the first metal piece with a high energy welding beam, the slot providing guide for the welding beam.

This method makes it possible, by providing guide for the welding beam via a slot, to assemble metal pieces by means of a high energy welding technique, even when the metal pieces have a different massiveness.

Throughout the description, the expression “metal piece” includes both a metal piece and a piece formed from an alloy.

In addition, two pieces are considered to have a “different massiveness” when these two pieces have volumes, dimensions and/or thicknesses that are relatively distinct from one another, i.e. where the ratio between the thickness of the first metal piece (e.g. the cover in the examples detailed below) and that of the second metal piece (e.g. the blade at its thinnest level, for the examples detailed below where the second piece is a blade with a progressive thickness) ranges from 1 to 10.

Further to the characteristics just discussed in the preceding paragraph, the assembly method according to one aspect of the invention may have one or more complementary characteristics from among the following, considered individually or according to any technically possible combinations:
the welding operation consists of electron beam welding.
the welding operation consists of LASER welding.
the second metal piece is positioned in a non-through configuration relative to the first metal piece.
the slot made during the slot making operation is a through slot, with a shape substantially similar to a profile of the second metal piece.

A second aspect of the invention relates to an assembly of a first and a second metal piece, obtained by the method defined above, wherein the first metal piece is a centrifugal diffuser cover and the second metal piece is a centrifugal diffuser blade, the cover and the blade being assembled by locally melting the metal of said metal cover and blade.

A third aspect of the invention relates to a centrifugal diffuser for a turbomachine including a metal cover and a plurality of metal blades, the cover having a substantially planar surface, the blades extending substantially perpendicularly to the planar surface of the cover, characterised in that each blade is assembled with the cover by means of the method as defined above.

Further to the characteristics just discussed in the preceding paragraph, the centrifugal diffuser according to one aspect of the invention may have one or more additional characteristics from among the following, considered individually or according to any technically possible combinations:
some of the plurality of blades are assembled with the cover in a through configuration and others of the plurality of blades are assembled in a non-through configuration.
each blade includes a blade portion assembled with the cover in a through configuration and a blade portion assembled with the cover in a non-through configuration.
a blade portion assembled with the cover in a non-through configuration is located at one end of the blade.

A fourth aspect of the invention relates to a turbomachine for aircraft, including a centrifugal diffuser as defined above, mounted at the outlet of a compressor of said turbomachine.

### BRIEF DESCRIPTION OF THE FIGURES

Further advantages and characteristics of the invention will become apparent upon reading the following description, illustrated by the figures in which:

FIG. 1, already described, represents a schematic longitudinal cross-section view of an example of a turbomachine according to the state of the art.

FIG. 2, already described, represents a schematic side view and a schematic perspective view of a diffuser according to the state of the art, deformed by the heat treatment of the soldering operation.

FIG. 3, already described, represents a schematic view of the profile of a diffuser blade according to the state of the art.

FIG. 4, already described, represents a schematic cross-section view of a cover/blade junction of a diffuser according to the state of the art during a EBW operation.

FIGS. 5A and 5B, already described, represent schematic cross-section views of a cover/blade junction of a diffuser according to the state of the art, respectively, in a through blade configuration and in a non-through blade configuration.

FIG. 6 represents a schematic cross-section view of a cover/blade junction of a diffuser according to the invention, before welding.

FIG. 7 represents a schematic perspective view of a diffuser cover according to the invention when blades are welded to said cover by means of high energy welding.

FIG. 8 represents a schematic cross-section view of a blade end welded to the diffuser cover according to the invention.

FIG. 9 represents a schematic perspective view of several blades of a diffuser according to the invention assembled in a through- and non-through-configuration.

FIG. 10 represents a functional diagram of the assembly method according to the invention.

FIG. 11 represents a top view and a truncated top view of an example of the diffuser according to the invention with a zone of non-through configuration at the blade tip.

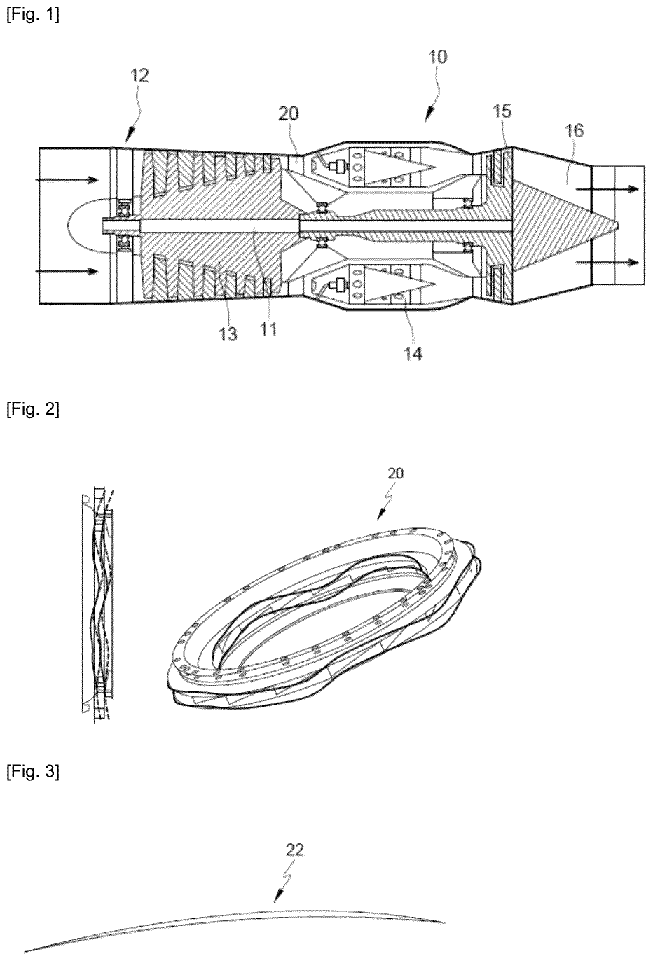

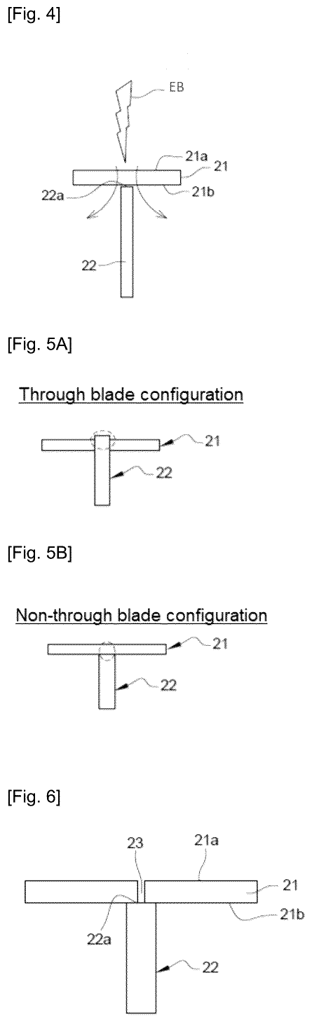

### DETAILED DESCRIPTION

An exemplary embodiment of a method for assembling a blade to a diffuser cover by high energy welding and an example of a blade and a diffuser cover assembled by this method are described in detail hereinafter, with reference to the appended drawings. These examples illustrate characteristics and advantages of the invention. It is reminded, however, that the invention is not limited to these examples.

In the figures, identical elements are marked by identical references. For reasons of legibility of the figures, the size scales between the elements represented are not respected.

Generally speaking, welding is a permanent assembly technique which establishes a continuity of nature between the welded pieces. The term weld is used to designate the metal, or alloy, connecting the pieces to be assembled, formed by melting the edges to be assembled, with or without the addition of a filler material. The weld may therefore be the result of the base metals alone (i.e. the pieces to be assembled) or of the mixture of the base metals and the filler material. During welding, there is local melting of the pieces to be assembled, unlike in soldering where there is never melting of the materials to be assembled.

High energy welding, such as electron beam welding or LASER welding, is a welding technique in which a high energy welding beam is applied to the pieces to be assembled to produce intense heat for melting the metal of the pieces to be assembled. The term ‘high energy’ means that the welding beam delivers a high local power of at least 10 KW/mm². In electron beam welding, or EBW, a beam of electrons bombards pieces to be assembled and produces a narrow, intense, three-dimensional heat source forming a hole or tunnel opening through the materials of the two pieces and travelling along the joint to be welded. In the laser welding technique, the electron beam is replaced with a LASER beam.

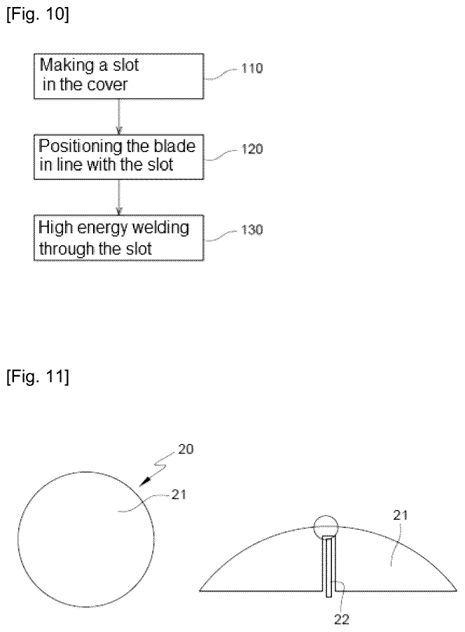

The method according to the invention, an example of which is functionally represented in FIG. 10, provides for assembling two metal pieces by high energy welding, avoiding any instability and/or deflection of the welding beam. An example of two metal pieces, in particular a blade 22 and a centrifugal diffuser cover 21, to be assembled using the method of the invention, is represented in FIG. 6. The following description will be given for a blade and a centrifugal diffuser cover, it being understood that the method of the invention may be implemented for any assembly of a first metal piece to be assembled with a second metal piece.

To allow welding without deflection of the high energy welding beam, the method according to the invention includes an operation 110 of making, on the external surface 21a of the cover 21, a slot 23 located facing the blade 22. This slot 23 is an opening passing right through the cover 21, in its thickness e. This slot 23 extends, on the cover, along at least part of the profile of the blade 22 with a shape substantially similar to said profile; this slot 23 may be, for example, substantially rectilinear or with the shape of an arc of a circle. In the example of FIG. 6, the slot 23 is made vertically aligned with the profile of the blade 22 in order to guide the high energy welding beam towards the top 22a of the blade to be welded in order to avoid deflection of said beam. The high energy welding beam, also referred to as the welding beam, electron beam or laser beam, is directed towards the slot 23 and follows the slot 23 along the entire length of said slot. The welding beam thus enables the metal of the cover 21 located in the vicinity of the slot 23 and the metal of the blade 22 located facing the slot 23 to be brought locally to their melting temperature. The two molten metals aggregate so that, after cooling, the two metal pieces are assembled.

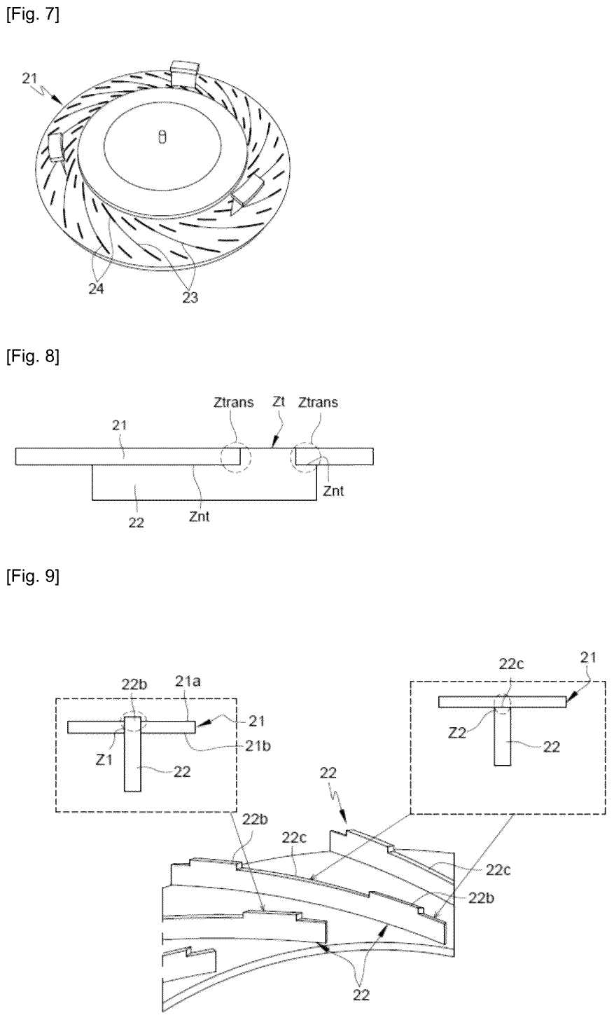

The slot can be made using techniques conventionally used for cutting metal pieces, such as LASER cutting or EDM (Electro Discharge Machining) cutting. An example of a centrifugal diffuser cover with several slots is represented in FIG. 7. This cover 21 includes slots 23 made for implementing the method according to the invention. These slots 23 enable blades (not visible in the figure) to be assembled on the cover 21, in a non-through configuration. FIG. 7 also shows apertures 24 used for assembling blades in a through configuration, explained later.

The method of FIG. 10 includes, after the operation 110 of making the slot 23, an operation 120 of positioning the blade 22 in line with the slot 23. Indeed, for the welding beam to ensure melting of the metals of the cover and the blade, it is necessary that the blade is positioned facing the slot, its top 22a extending substantially perpendicular to the inner surface 21b of the cover 21. Once the blade 22 has been positioned, the high energy welding operation 130 is implemented using an adapted welding device. This welding operation 130 is executed, as explained previously, by bringing the metal of the top of the blade 22 and the metal of the part of the cover 21 adjacent to the slot 23 to their melting temperature, so as to obtain a melting zone Z2 which will ensure, after cooling, the assembly of both pieces.

In some embodiments, some blades 22 are assembled with the cover in a non-through configuration and others in a through configuration.

In some other embodiments, the blades 22 are partially assembled with the cover in a through configuration and partially in a non-through configuration. An example of such an assembly is represented in FIG. 9. FIG. 9 shows blades 22 including extended portions 22b and normal portions 22c. The extended portions 22b are portions of the blade 22 which project longitudinally from the normal portions 22c of the blade. The extended portions 22b are designed to be inserted into the apertures 24 of the cover 21 in the through configuration. These extended portions 22b, housed in the apertures 24, are assembled with the cover 21 by a conventional high energy welding operation in which the welding beam induces melting of the metal of the extended portion 22b and the metal of the cover around this extended portion, creating a first molten zone Z1. The normal portions 22c of the blade 22 are each positioned against a slot 23 in the cover, in line with said slot. The assembly of these normal zones 22c with the cover 21 is obtained after the welding beam has passed through the slot 23, i.e. along the normal portion 22c of the blade. Passage of the welding beam through the slot 23 generates a second molten zone Z2.

Thus, as previously explained, the slot 23 in the cover 21 makes it possible to guide and focus the welding beam on the top 22a of the blade in the zones of non-through configuration. As this slot 23 is made facing the normal portion 22c of the blade 22, it offers an additional advantage when positioning the cover. Indeed, this slot 23 makes it possible to check, before welding, whether the positioning of the cover 21 in relation to the blades 22 is correct. Several techniques are currently used to check positioning of the cover in relation to the blades (for example the use of a mechanical detection tool or an optical tool); checking by means of the slot 23 makes it possible either to replace the usual technique or to confirm the positioning check, with the advantage of being simple to implement, without requiring additional costly means.

The assembly method with welding through slot 23, as described above, solves the problem caused by the difference in massiveness between the blade and the cover. In the embodiments in which each blade is assembled partly in the through configuration and partly in the through configuration, the difference in massiveness is particularly present at the blade tip, i.e. in the zone close to the end of said blade. In fact, at the blade tip, the difference in massiveness not only results in a difference in the thickness of the pieces (about 0.2 to 0.3 mm for the top of the blade and about 2 to 3 mm for the cover) but also in a transition zone in the configuration mode when shifting from the through configuration to the non-through configuration. In this transition zone, the change of configuration generates significant variations in thickness, especially as the blade profile is very thin therein. An example of a blade tip assembly is schematically represented in FIG. 8 with the zone Zt for the through configuration, the zone Znt for the non-through configuration and the transition zone Ztrans. To avoid variability during the welding operation in the transition zone Ztrans, the method includes an operation of adjusting positioning of the through configuration zone Zt, which has to be positioned as close as possible to the edge of the blade 22 in order to take optimum advantage of the weldability offered by the through configuration. In addition to this adjustment operation, and in contrast, it is chosen to retain a zone of non-through configuration Znt at the blade tip. A schematic example of a diffuser according to the invention with a zone of non-through configuration Znt at the blade tip is represented in FIG. 11. This choice of a zone with a non-through configuration Znt at the blade end avoids many problems. Indeed, if a zone with a through configuration Zt were positioned at the very end of the blade 22, then:
on the one hand, the welded cover 21 at the top of the blade would have a weakened zone on its external diameter (depicted by a circle in FIG. 11) which would be likely to deform under the effect of the welding operation. The height of the air stream defined by the height of the blade internal to the diffuser would then be uncontrolled on either side of the blade with, moreover, a deformed diffuser cover in this zone; and
on the other hand, the use of tooling to position this weakened zone for the purpose of holding it in place during the welding operation would introduce unnecessary industrial complexity, mainly due to the overall size of the elements involved (blades, cover, blade height, juxtaposition of the blades in relation to each other, etc.).

Keeping a zone of non-through configuration Znt at the blade tip makes it possible not only to avoid the problems set out above but also to weld the thinnest zone of the blade 22, to ensure that the cover 21 is held in place and to limit manufacturing costs by avoiding complex implementation.

Although described through a number of examples, alternatives and embodiments, the assembly method according to the invention, the assembly itself and the diffuser produced by implementing this method comprise various alternatives, modifications and improvements which will be obvious to the person skilled in the art, it being understood that these alternatives, modifications and improvements are within the scope of the invention.

1. A method for assembling a first metal piece to a second metal piece, the first and second metal pieces having a different massiveness, the second piece being assembled with the first metal piece at least partially in a non-through configuration, and the method comprising the following operations of:
a) making, on a surface of the first metal piece, a slot passing right through said first metal piece in its thickness (e),
b) positioning the second metal piece in line with the slot of the first metal piece, against said slot, and
c) welding, through the slot, the second metal piece to the first metal piece with a high energy welding beam, the slot providing guide for the welding beam.

2. The method according to claim 1, wherein the welding operation consists of electron beam welding.

3. The method according to claim 1, wherein the welding operation consists of LASER welding.

4. The method according to claim 1, wherein the slot formed during operation a) includes a shape substantially similar to a profile of the second metal piece.

5. An assembly of a first and a second metal piece, obtained by the method according to claim 1, wherein the first metal piece is a centrifugal diffuser cover and the second metal piece is a centrifugal diffuser blade, the cover and the blade being assembled by locally melting the metal of said metal cover and blade.

6. A centrifugal diffuser for a turbomachine including a metal cover and a plurality of metal blades, the cover including a substantially planar surface, the blades extending substantially perpendicularly to the planar surface of the cover, wherein each blade is assembled with the cover by means of the method according to claim 1.

7. The centrifugal diffuser according to claim 6, wherein some of the plurality of blades are assembled with the cover in a through configuration and others of the plurality of blades are assembled in a non-through configuration.

8. The centrifugal diffuser according to claim 6, wherein each blade includes a blade portion assembled with the cover in a through configuration and a blade portion assembled with the cover in a non-through configuration.

9. The diffuser according to claim 8, wherein a blade portion assembled with the cover in a non-through configuration is located at one end of the blade.

10. A turbomachine for aircraft, including a centrifugal diffuser according to claim 6 mounted at the outlet of a compressor of said turbomachine.
